(19) United States
(12) Patent Application Publication
(10) Pub. No.: US 2005/0046768 A1
(43) Pub. Date: Mar. 3, 2005

(54) Reversible liquid crystal display

(76) Inventor: Heng Chung Wu, Hsin Chu Hsiang (TW)

Correspondence Address: BIRCH STEWART KOLASCH & BIRCH, PO BOX 747, FALLS CHURCH, VA, 22040-0747, US

(21) Appl. No.: 10/646,692

(22) Filed: Aug. 25, 2003

(51) Int. Cl. G02F 1/1335

(52) U.S. Cl. 349/65

(57) ABSTRACT

A reversible liquid crystal display (LCD) has a transmissive liquid crystal module, a pair of light-guiding plates respectively disposed on two sides of the transmissive liquid crystal module, and at least one light for supplying light to the pair of light-guiding plates.

### BACKGROUND OF THE INVENTION

1. Field of the Invention

The present invention relates to a reversible liquid crystal display (LCD), which is an LCD with a single display module and is reversible, and particularly as applied on a liftable lid electronic equipment for display on double faces.

2. Description of the Prior Art

According to the development of information, communication and networking, compact portable mobile products have become important for daily use, and therefore the liquid crystal displays (LCD) of the mobile products have become an important element. Because an LCD does not itself contain a light source, it needs an additional light for providing a uniform, bright display. Conventional LCDs can be classified into two types according to the type of light employed, a backlight module la and a frontlight module 2a. The backlight module la is mainly applied to transmissive panels and trans-reflective panels. The light 10a usually is a dot or linear light and is coordinated with a reflecting hood 11a. Light is reflected by a reflector 12a and then enters the light-guiding board 13a. The light-guiding board 13a converts the light into a uniform flat light. Diffuser 14a and equalizes the light and micro-rhombus mirror 15a converges the light, making the light brighter and more uniform.

The frontlight module 2a is mainly used in reflective LCD panel 24a. A dot or linear light 20a is guided into a condensing plate 22a via a reflecting hood 21a, and the light is converted into uniform, flat light via a micro-structure 23a which is formed on a front surface of a condensing plate 22a.

LCDs are often applied in a unit of electronic equipment with a liftable lid for double display, such as, for example, a cell phone to reduce volume and increase color display. Referring to FIGS. 3 and 3a, the liftable lid cell phone actually has two LCDs, a color LCD disposed inside for the main display, and a black-and-white LCD disposed outside for the secondary display. A backlight is disposed therebetween. This increases the thickness of the cell phone and thus manufacturing cost, as well as increasing power consumption to shorten the standby time.

### SUMMARY OF THE INVENTION

An object of the present invention is to provide a reversible liquid crystal display, particular to an LCD having a single display with two surfaces thereof viewable for effectively reducing thickness and extending standby time of an electronic product.

In order to achieve the above objects, the present invention provides a reversible liquid crystal display (LCD), comprising a transmissive liquid crystal module, a pair of light-guiding plates respectively disposed on two sides of the transmissive liquid crystal module, and at least one light for supplying light to the pair of light-guiding plates.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a backlight-type LCD;

FIG. 2 is a perspective view of a frontlight-type LCD;

FIG. 3 is a perspective view of a conventional cell phone, opened;

FIG. 3A is a perspective view of a conventional cell phone, closed;

FIG. 4 is a perspective view of a reversible LCD of the present invention;

FIG. 5 is a perspective view of second embodiment of the reversible LCD according to the present invention; and

FIG. 6 is a perspective view of the reversible LCD according to the present invention applied in a cell phone.

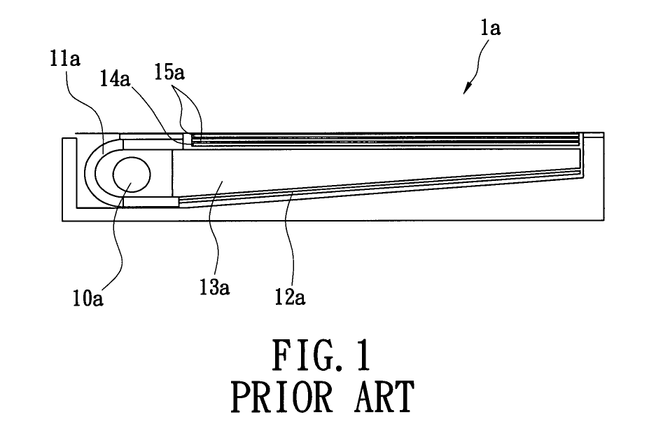

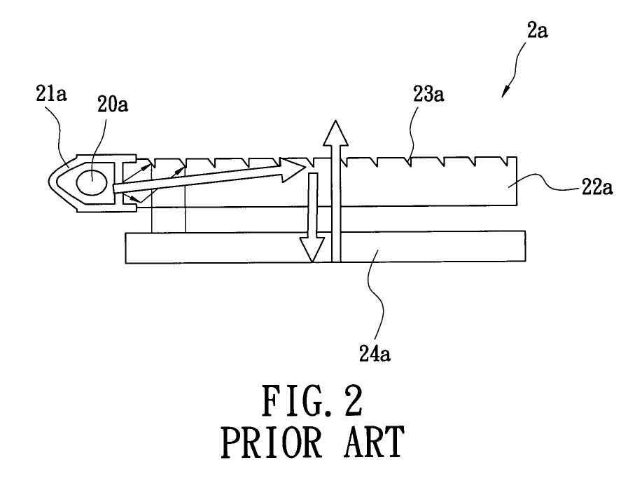

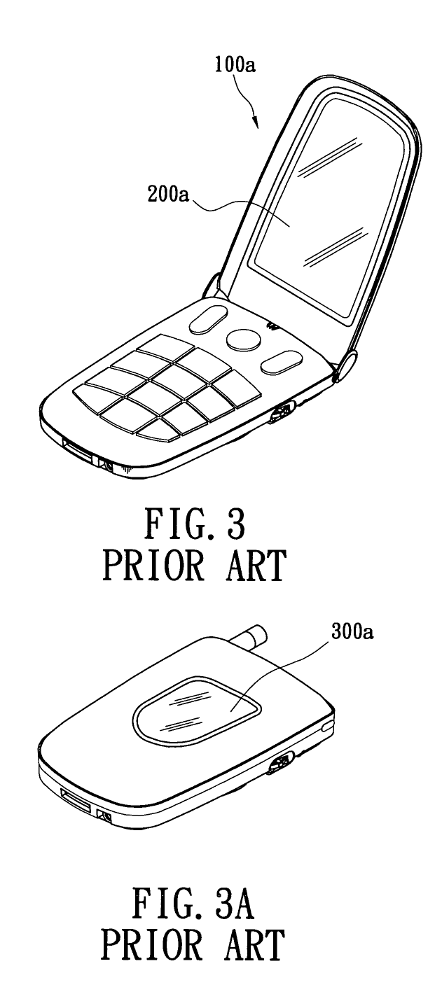

### DESCRIPTION OF THE PREFERRED EMBODIMENT

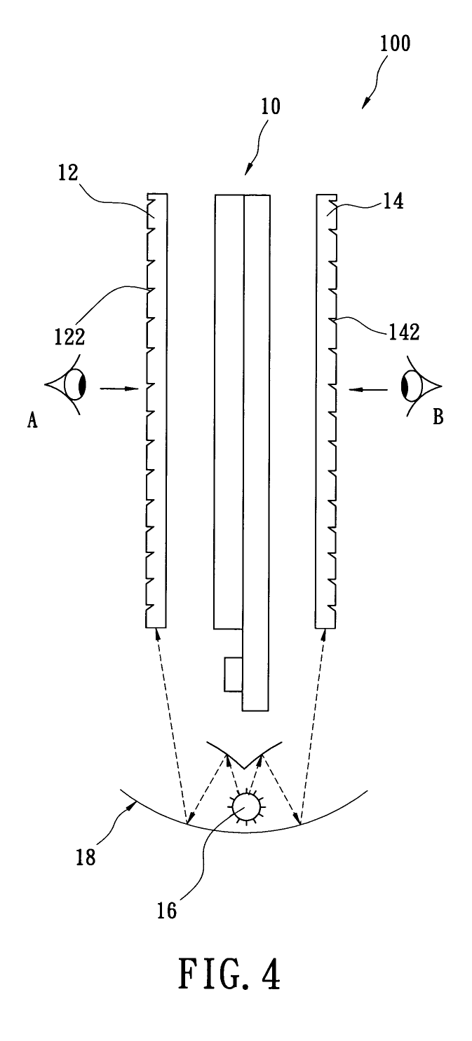

FIG. 4 is a perspective view of a reversible LCD of the present invention. The reversible LCD 100 includes a transmissive liquid crystal module 10, a pair of light-guiding plates 12, 14 respectively disposed on two sides of the transmissive liquid crystal module 10, and a light 16 for supplying light to the pair of light-guiding plates 12, 14. The light-guiding plates 12, 14 are made of transparent material or thin film light-guiding material, and are respectively formed with a plurality of micro-rhombuses 122, 142 therein for reflecting light. For condensing light, a condenser 18 is disposed adjacent to the light 16 for guiding light to the light-guiding plates 12, 14.

When the LCD 100 is reversed to reveal the other side thereof, the images on the LCD 100 are reversed in an up-to-down or right-to-left way, and therefore need an image-reversing unit to reverse images on the liquid crystal. This is well known in the art and therefore not further described.

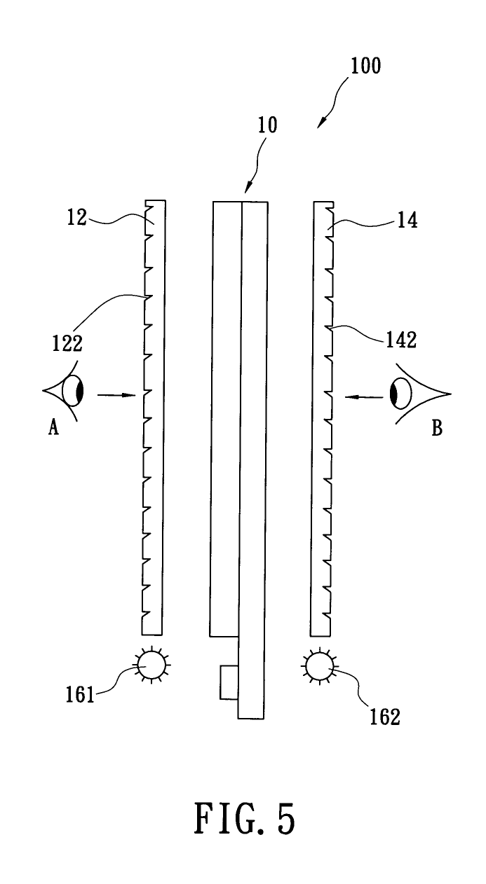

FIG. 5 is a second embodiment of the reversible liquid crystal display of the present invention. The reversible LCD 100 comprises two lights 161, 162 respectively corresponding to the pair of light-guiding plates 12, 14. The reversible LCD 100 further comprises a controlling unit, for example, a controlling software in a chip and mounted therein for turning the two lights on or off, thereby turning off the front light of the LCD and turning on the back light of the LCD when turning over the LCD. For example, when viewing from point A, light 162 is turned on and light 161 is turned off. Conversely, when viewing from point B, light 161 is turned on and light 162 is turned off. The reversible LCD 100 further comprises a sensor corresponding to the controlling unit for sensing when LCD 100 is reversed, for example a push button or a swiveling mechanism (not shown).

The liquid crystal module can be applied in OLED (organic light-emitting diode), PLED (polymer light-emitting diode), PDP (plasma display panel), or LCD (liquid crystal display).

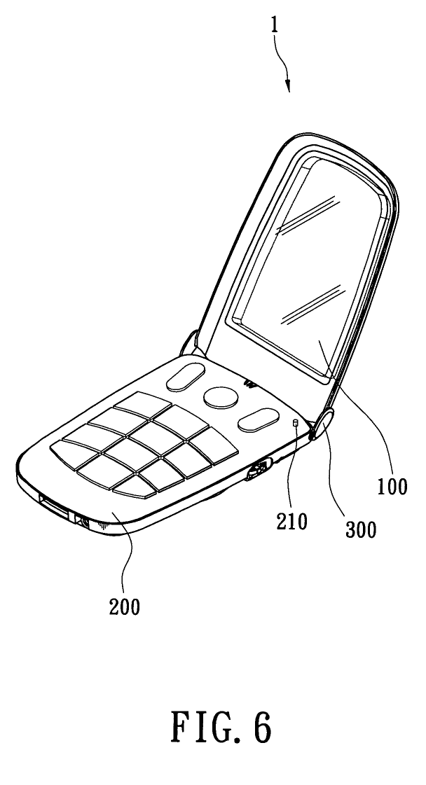

FIG. 6 is a perspective view of the reversible LCD according to the present invention applied in a cell phone. The cell phone comprises a display panel with a reversible LCD 100 assembled therein, an operating portion 200 with a plurality of operating buttons assembled thereon and a connecting portion 300 connecting the display panel to the operating portion 200. A sensing unit is assembled in the operating portion 200 or the connecting 300, such as a sensing switch 210, is assembled on the operating portion 200, thereby coordinating the sensing switch 210 with an image reversing unit for reversing images of the liquid crystal module up-to-down, or right-to-left in response to the LCD 100 being reversed. The reversible LCD not only can be applied on a cell phone, but also to any unit of electronic equipment with a liftable lid, such as a notebook, or a personal digital assistant.

Therefore, the reversible liquid crystal display of the present invention is particularly applied in a unit of electronic equipment with a liftable lid, effectively reducing both the thickness and cost thereof.

Although illustrated and described herein with reference to certain specific embodiments, the present invention is nevertheless not intended to be limited to the details shown. Rather, various modifications may be made in the details within the scope and range of equivalents of the claims and without departing from the invention.

1. A reversible liquid crystal display (LCD), comprising:
a transmissive liquid crystal module;
a pair of light-guiding plates respectively disposed on two sides of the transmissive liquid crystal module, and
at least one light for supplying light to the pair of light-guiding plates.

2. The reversible liquid crystal display as claimed in claim 1, wherein the pair of light-guiding plates are made of transparent material, and formed with a plurality of micro-rhombuses for reflecting light.

3. The reversible liquid crystal display as claimed in claim 1, wherein the pair of light-guiding plates are made of thin film light-guiding material, and formed with a plurality of micro-rhombuses for reflecting light.

4. The reversible liquid crystal display as claimed in claim 1, wherein the light is single, and a condenser is disposed adjacent to the light for guiding light to the light-guiding plates.

5. The reversible liquid crystal display as claimed in claim 1, further comprises an image reversing unit for reversing images of the liquid crystal module up-to-down, or right-to-left in response to the LCD being reversed.

6. The reversible liquid crystal display as claimed in claim 1, wherein the reversible LCD comprises two lights respectively corresponding to the pair of light-guiding plates.

7. The reversible liquid crystal display as claimed in claim 6, further comprising a controlling unit for turning the two lights on or off, thereby turning the front light of the LCD on and turning the back light of the LCD off when turning over the LCD.

8. The reversible liquid crystal display as claimed in claim 6, further comprising a sensor for sensing reversal of the LCD.

9. The reversible liquid crystal display as claimed in claim 1, wherein the liquid crystal module is an OLED (organic light-emitting diode), PLED (polymer light-emitting diode), PDP (plasma display panel), or LCD (liquid crystal display).

10. The reversible liquid crystal display as claimed in claim 1, wherein the reversible LCD is assembled on a unit of electronic equipment with a liftable lid.

11. A unit of electronic equipment with a liftable lid and a reversible liquid crystal display (LCD), comprising:
a display panel, having a reversible LCD assembled therein, wherein the reversible LCD comprises:
a transmissive liquid crystal module;
a pair of light-guiding plates respectively disposed on two sides of the transmissive liquid crystal module; and
at least one light for supplying light to the pair of light-guiding plates;
an operating portion, having a plurality of operating buttons assembled thereon; and
a connecting portion, connecting the display panel to the operating portion.

12. The unit of electronic equipment with a liftable lid and a reversible liquid crystal display as claimed in claim 11, wherein the unit of electronic equipment is cell phone, notebook, or personal digital assistant.

13. The unit of electronic equipment with a liftable lid and a reversible liquid crystal display as claimed in claim 11, wherein the pair of light-guiding plates are made of thin film light-guiding material and formed with a plurality of micro-rhombuses for reflecting light.

14. The unit of electronic equipment with a liftable lid and a reversible liquid crystal display as claimed in claim 11, wherein the pair of light-guiding plates are made of transparent material and formed with a plurality of micro-rhombuses for reflecting light.

15. The unit of electronic equipment with a liftable lid and a reversible liquid crystal display as claimed in claim 11, wherein the light is single, and a condenser is disposed adjacent to the light for guiding light to the light-guiding plates.

16. The unit of electronic equipment with a liftable lid and a reversible liquid crystal display as claimed in claim 11, further comprising a sensor for sensing reversal of the LCD

17. The unit of electronic equipment with a liftable lid and a reversible liquid crystal display as claimed in claim, 16, wherein the sensor is mounted on the operating portion or the connecting portion.

18. The unit of electronic equipment with a liftable lid and a reversible liquid crystal display as claimed in claim 11, further comprising an image-reversing unit for reversing images of the liquid crystal module up-to-down or right-to-left in response to the LCD being reversed.

19. The unit of electronic equipment with a liftable lid and a reversible liquid crystal display as claimed in claim 11, wherein the display panel comprises two lights respectively corresponding to the pair of light-guiding plates

20. The unit of electronic equipment with a liftable lid and a reversible liquid crystal display as claimed in claim 11, further comprising a controlling unit for turning the two lights on or off, wherein the controlling unit turns off the light near the user and turns on the light away from the user corresponding to a display module being reversed.
